(19) United States
(12) Patent Application Publication
(10) Pub. No.: US 2008/0319980 A1
(43) Pub. Date: Dec. 25, 2008

(54) METHODS AND SYSTEM FOR INTELLIGENT NAVIGATION AND CACHING FOR LINKED ENVIRONMENTS

(75) Inventors: Jeremy PICKENS, Milpitas, CA (US); Monika GORKANI, San Jose, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/965,625

(22) Filed: Dec. 27, 2007

Related U.S. Application Data
(60) Provisional application No. 60/945,889, filed on Jun. 22, 2007.

(51) Int. Cl. G06F 17/30

(52) U.S. Cl. 707/5; 707/E17.108

(57) ABSTRACT

A real-time, content-based document navigation and caching tool for use within linked-document environments. The system includes a combination of rooted spidering, ranking and displaying to provide the user with a capability to perform intelligent navigation of the document collection. The system allows users to intelligently browse their local information environments, finding the documents that are most relevant to their information needs but also respecting the locality of the user's current location within the hyperlinked environment.

### REFERENCE TO RELATED APPLICATION

This application claims the benefit of Provisional Patent Application No. 60/945,889 filed Jun. 22, 2007, the disclosure of which is incorporated herein by reference, in its entirety.

### FIELD OF THE INVENTION

This invention generally relates to information retrieval and more specifically to intelligent navigation and caching for linked information environments.

### BACKGROUND OF THE INVENTION

Traditional information retrieval algorithms operate on large collections of independent documents. In such independent document collections, one document may be conceptually similar, but in no way explicitly connected, to another document. A linked-document environment is different in that it is a collection in which the documents reference or connect to one another. Examples of the linked-document environments include, without limitation, a scientific paper environment, wherein citations to published articles serve as links between documents; email repositories, wherein To: and From: fields operate as linking structures; a “help and support” hypertext document with links to various chapters and subtopics, such as those found accompanying many modern software applications; or any other document repository to which metadata about related documents or information sources have been added.

When searching for information in linked-document environments, there are two main strategies that a user can take. First, the user can employ an ad hoc information retrieval engine, such as Google search engine, enter a single or multiple query words and get a ranked list of documents most relevant to the user's query topic. Second, the user can start at one page or document in the collection and iteratively browse through the collection by following near-neighbor links. The problem with the aforesaid first approach is that, while certain ad hoc search algorithms, such as Google's PageRank, make use of hyperlinked structure to find the most popular (and therefore, often, the most relevant) pages, they do so based on global (collection-wide) link counts. For this reason, such ad hoc search algorithms do not take into account the information in the local neighborhood of the user's current context, such as information in documents, which are linked to the user's current document.

On the other hand, the problem with the second approach is that the user is dependent on the link-associated information, such as link metadata, text surrounding a link as well as similar information, for making user's browsing decision. If the link or the information surrounding the link does not sufficiently describe the object to which the link is pointing, the user will have a difficult time making the correct navigation decisions. Thus, neither of the above two conventional approaches is satisfactory.

Thus, the conventional approaches are deficient in their ability to facilitate efficient searching and retrieval of information in linked-document environments.

### SUMMARY OF THE INVENTION

The inventive methodology is directed to methods and systems that substantially obviate one or more of the above and other problems associated with conventional techniques for information searching and retrieval.

In accordance with one aspect of the inventive methodology, there is provided a method involving: receiving a user query from a user; transmitting the user query to a search engine; receiving search results from the search engine and providing the user with the received search results; receiving a landing document selection from the user, the landing document being selected by the user from the search results; performing a crawl of links rooted in the selected landing document to identify a plurality of link-near documents; sorting the plurality of the identified plurality of link-near documents; and presenting the sorted plurality of the identified plurality of link-near documents to the user.

In accordance with another aspect of the inventive methodology, there is provided a method involving receiving a landing document selection from a user. The received landing document can be selected by the user from a collection of link-connected documents. The inventive method further involves performing a crawl of links rooted in the selected landing document to identify a plurality of link-near documents; sorting the plurality of the identified plurality of link-near documents; and presenting the sorted plurality of the identified plurality of link-near documents to the user.

In accordance with yet another aspect of the inventive methodology, there is provided a method involving receiving a landing document selection from a user. The received landing document can be selected by the user from a collection of link-connected documents. The inventive method further includes performing a crawl of links rooted in the selected landing document to identify a plurality of link-near documents and caching the plurality of the identified plurality of link-near documents for subsequent access by the user.

In accordance with a further aspect of the inventive methodology, there is provided a computer-readable medium embodying a set of computer-executable instructions implementing a method involving receiving a user query from a user; transmitting the user query to a search engine; receiving search results from the search engine and providing the user with the received search results. The aforesaid method further involves receiving a landing document selection from the user, the landing document being selected by the user from the search results; performing a crawl of links rooted in the selected landing document to identify a plurality of link-near documents; sorting the plurality of the identified plurality of link-near documents; and presenting the sorted plurality of the identified plurality of link-near documents to the user.

In accordance with yet further aspect of the inventive methodology, there is provided a system incorporating a rooted spidering module configured to receive a landing document selection from a user. The aforesaid rooted spidering module is further configured to perform a crawl of links rooted in the selected landing document to identify a plurality of link-near documents. The inventive system further incorporates a ranking module operable to sort the plurality of the identified plurality of link-near documents; and a user interface operable to present the sorted plurality of the identified plurality of link-near documents to the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive system.

FIG. 2 illustrates an exemplary embodiment of a linked document environment.

FIG. 3 illustrates an exemplary embodiment of the inventive rooted spidering.

FIG. 4 illustrates an exemplary embodiment of an inventive side bar.

FIG. 5 illustrates an exemplary embodiment of the inventive system.

FIG. 6 illustrates an exemplary operating sequence of an embodiment of the inventive system.

FIG. 7 illustrates a Breadth First spidering technique.

FIG. 8 illustrates a Best First Spidering technique.

FIG. 9 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In one embodiment of the invention, the weaknesses of both of the aforesaid traditional information search and retrieval approaches are addressed by providing a user with an ad hoc, ranked list navigation interface to the set of link-local documents connected to a given starting page. In this manner, the user has the best of both approaches: intelligent navigation based on the relevance to a user's information need, rather than the exact link structure created by the website (or document collection) creator.

Thus, in accordance with one embodiment of the inventive concept, there is provided a real-time, content-based document navigation and caching tool for use within linked-document environments. An embodiment of the inventive intelligent navigation tool allows users to traverse a linked document environment while simultaneously retaining the relevance focus of their initial query. In other words, an embodiment of the inventive system and technique allows users to intelligently browse their local information environments, finding the documents that are most relevant to their information needs, while giving a consideration to the information in the immediate vicinity of the user's current location within the hyperlinked environment.

Various embodiments of the inventive approach may include, without limitation, one or more of the following features, singly or in any combination: (1) query time spidering or crawling, from an ad hoc root and based on the relevance of a user's information need; (2) integration of this spidering with a ranking and navigation side bar, to allow the user to follow local links, but in a relevance-ordered manner rather than in a link-structure-ordered manner; and (3) intelligent caching of the found resources for offline browsing. Specific embodiments and implementations of the inventive approach will now be described in detail.

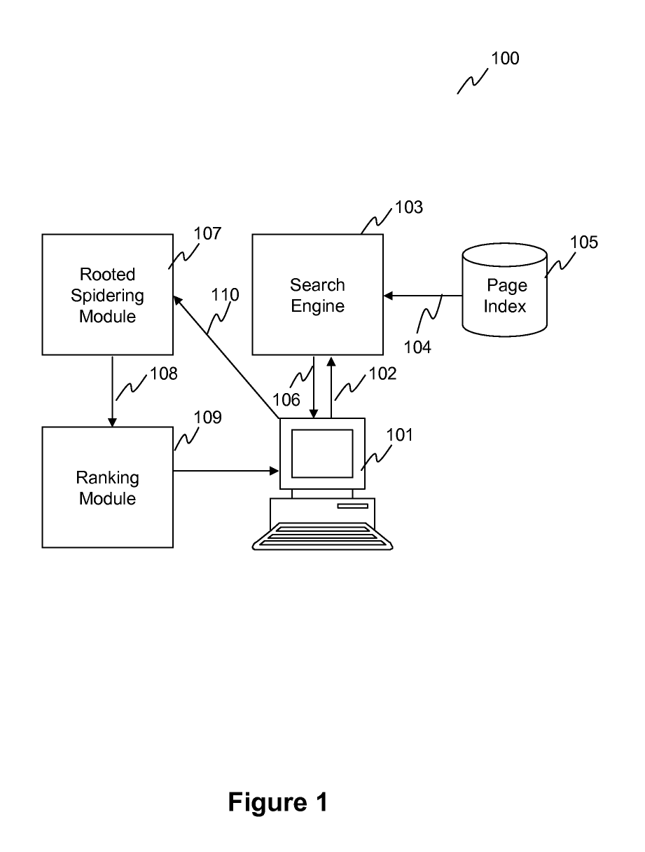

FIG. 1 illustrates an exemplary embodiment of the inventive search system 100. In the system 100 shown in FIG. 1, a user uses a user interface (not shown) generated by the user terminal 101 to issue a query 102 to a search engine 103. The query 102 contains one or more keywords describing the information that the user seeks. The search engine 103 receives the search query 102 from the user terminal 101 and performs a search of pages or other documents 104 in a page index 105 based on the search terms contained in the search query 102. The indexed search results 106 are passed back to the user terminal 101 and displayed to the user. The user browses through the search result and selects a page within the indexed results, which, according to user's opinion, is relevant to the information that the user is looking for. This page will be referred to herein as “landing” page. The information 110 on the user's selection of the landing page is passed to an inventive rooted spidering module 107. Based on the received information 110, the rooted spidering module 107 proceeds to perform relevance-based crawl of links rooted in the landing page and generates a list of linked pages 108, which is passed to the ranking module 109. The ranking module 109 performs ranking of the found linked pages and passes the ranked linked page list 111 to an inventive user interface (not shown) residing on the user terminal 101. Upon receipt of the ranked linked page list 111, the inventive user interface displays it to the user.

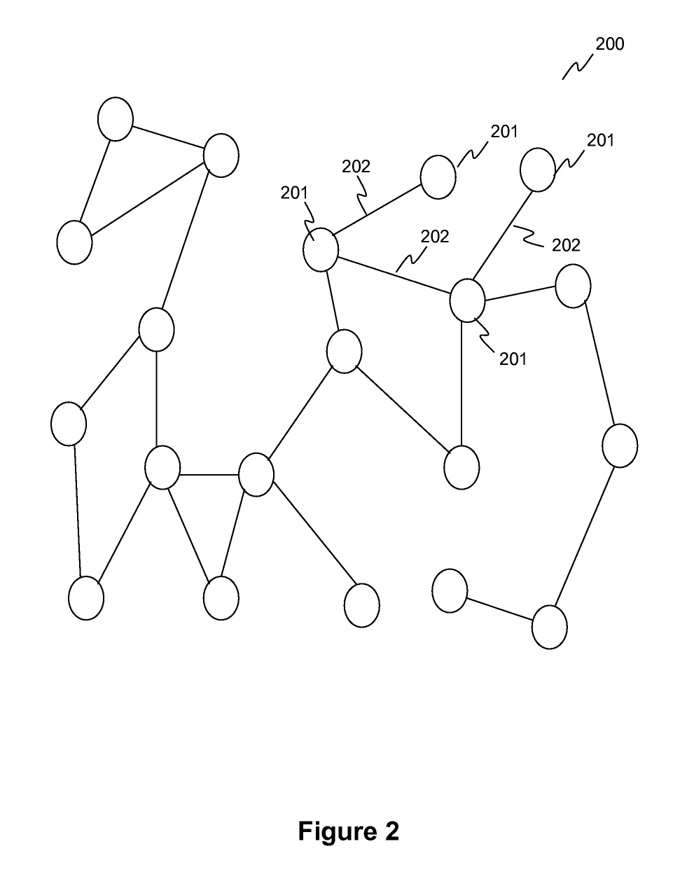

FIG. 2 illustrates an exemplary embodiment of a collection of documents which are linked to each other, to which the inventive searching techniques may be applied. In the shown embodiment, documents 201 are connected with links 202. Each document 201 may originate one or more links 202, which may be either unidirectional or bidirectional.

The user can “land on” or otherwise arrive at one of the documents 201, for example, as the result of a traditional keyword search and subsequent selection of the “landing page” in the ranked results list. The problem with the traditional keyword search approach is that the landing page or the landing document might be generally relevant to the user's information need, but does not contain the exact information that the user is seeking. The user must then manually browse the linked documents by following a link, evaluating the new page, and then either backing up to the previous page or choosing yet another link to manually follow. Furthermore, different links may be scattered throughout the landing page, and the user has to manually hunt them all down to determine which ones to follow.

To overcome the aforesaid deficiencies of the traditional keyword searching, an embodiment of the inventive system shown in FIG. 1 combines rooted spidering, ranking, and a navigational results interface to allow users to quickly assess and follow the best documents linked, locally, to the current document. The components of an embodiment of the inventive system shown in FIG. 1 will now be described in detail.

### Rooted Spidering Module

Spidering performed by the rooted spidering module 107 may include adding all the links found on a landing page 110 to a queue, following those links, adding the links found on the new pages to the queue, and repeating the above steps a predetermined number of times. Traditionally, spidering occurs at index time, prior to an actual search. Documents are cached and processed for later searching, and links are analyzed to estimate the quality or popularity of a page. Thus, spidering traditionally concludes before the actual search begins.

In an embodiment of the invention shown in FIG. 1, however, an additional step of a post-query spidering is introduced, where additional (to the landing document) documents are discovered based on their link-local proximity to the current document (the spidering is rooted in the landing document). Whether the links found during the spidering step have already been discovered at index time, or are re-crawled at query time, is not germane to the shown embodiment of the inventive technique. The inventive post-query spidering performed by the rooted spidering module 107 enables to quickly discover the N link-nearest documents, i.e. the N documents that are connected by links, transitively, to the landing document.

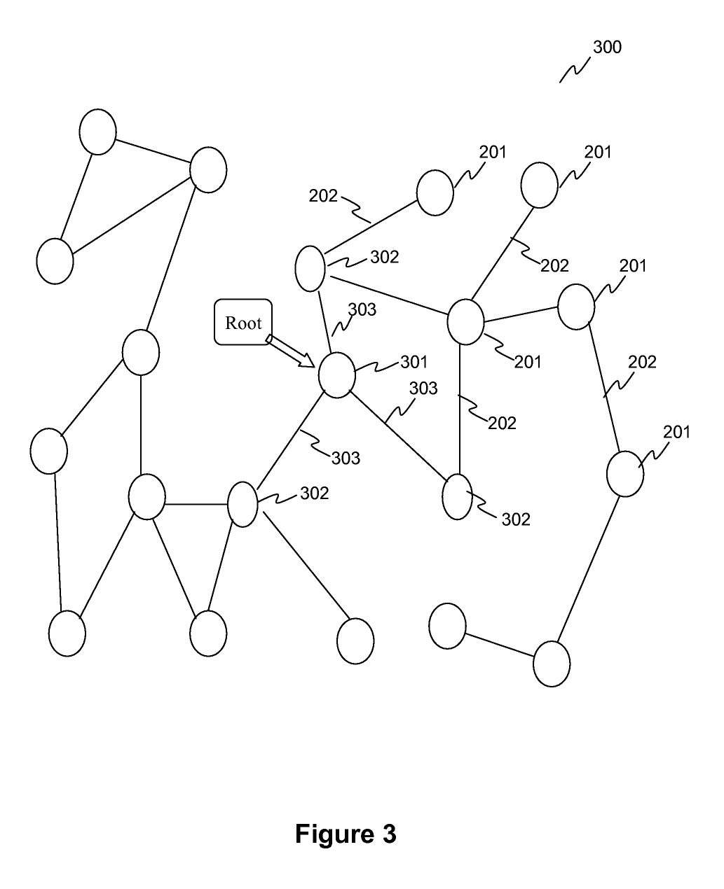

FIG. 3 illustrates a linked document collection 300 having a document root 301. Links 303 extending from the root 301 to neighboring documents 302 are the first ones discovered in a crawl performed by the module 107.

### Ranking Module

Now that the embodiment of the inventive system has discovered the N link-nearest documents using the rooted spidering module 107 and the landing page selected by the user, the embodiment of the inventive system then ranks these documents using the ranking module 109. An embodiment of the ranking module 109 uses either of the two well-known methods for ranking the N documents, or both such methods. These methods include query-based ranking and document similarity-based ranking. The choice of the appropriate ranking method or methods depends on the particular application.

In a first scenario, the user arrives at the root (landing) page via an initial query issued to a search engine. In other words, the user performs a standard query search and then clicks one of the links returned by the search engine. In this case, the ranking of the N link-nearest documents can be done by comparing each of the N documents to the original query, as typically done for any document in the collection during a traditional query search. Embodiments of the ranking module 109 may rely on any known technique for comparing a document to a query, including, without limitation, the TF.IDF comparison technique, language model-based techniques, Okapi technique, vector space models-based techniques, and the like. The above-mentioned comparison techniques are well known to persons of ordinary skill in the art.

In addition to the aforesaid comparison techniques, the inventive ranking module 109 my use any other standard features of the N link-nearest documents, such as global link popularity thereof or the like measures. The difference between the described embodiment of the inventive methodology and the conventional search and ranking techniques is that, while global link analysis may be used to rank the N documents, the rooted spidering performed by the corresponding module 107 insures that rankings in the embodiment of the inventive system are not done globally, but are instead done locally, respecting the link neighborhood.

In a second scenario, the user has not provided an initial query, but instead started with the root document and wants to traverse links originating from that document that are most similar to the root document. In this scenario, the similarity function should be document-based rather than query-based. Specifically, an embodiment of the inventive concept uses a full document similarity metric in the vector space model in order to calculate the similarity between the root document and the N link-nearest documents that are being ranked. In another embodiment, the module 109 operates to extract discriminating keywords from the root document 110 and uses those extracted keywords for retrieval. Such method has been well known to persons of ordinary skill in the art. Thus, the present invention is not limited to any specific metric for determining the similarity between the root document and the N link-nearest documents found by the rooted spidering module 107.

### User Interface for Presentation of the Ranked, Root-Spidered Documents

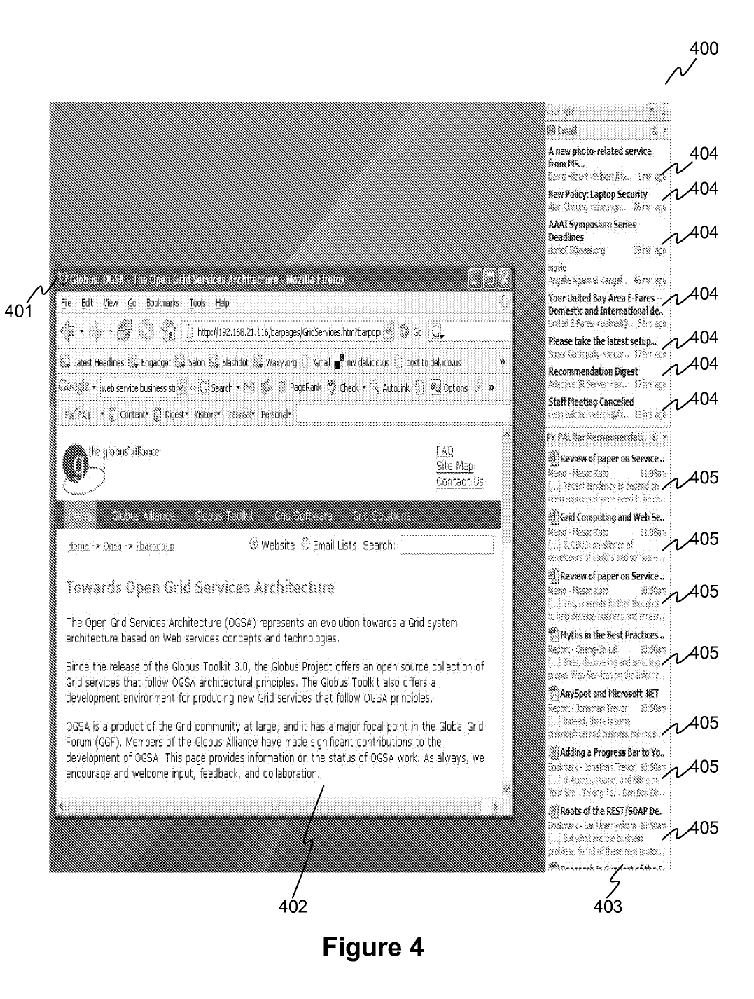

After the embodiment of the inventive systems has ranked the N link-nearest documents, it presents them to the user in an appropriate manner. In one embodiment of the invention, the ranked list of link-nearest documents is presented to the user using a side bar interface. An exemplary embodiment 400 of such interface is illustrated in FIG. 4. Specifically, the interface shown in FIG. 4 includes a root document display window 401 displaying a root document 402. The ranked lists of documents nearest in the link space to the root document 402, which are generated by an embodiment of the inventive system, are displayed in linked document windows 403 and 406 on the right side of the document window 401. Specifically, window 406 displays a ranked list of link-nearest documents 404 from a collection of user's email messages. On the other hand, window 403 displays a ranked list of link-nearest documents 405 from some other document collection, such as collection of web pages. The user of the embodiment of the inventive system may is provided with an option to click on or otherwise select one of the link-nearest documents displayed on the right side, whereupon the selected document becomes a new root document, with the embodiment inventive system generating ranked list(s) of documents nearest in the link space to the new root document and similarly displaying those ranked list(s) in the side bar windows 403 and 406.

Thus, the described embodiment of the inventive technique presents the user with documents, similar to the root document, selected from a collection that have been restricted, via the rooted spidering module 107, to the documents that are link-nearest to the given root document. The selected link-nearest documents are sorted by their relevance and presented to the user in a convenient manner. It should be noted that the inventive system is not limited to the described side-bar interface. Any suitable user interface may be used for displaying the generated ranked list of link-nearest documents.

Thus, an embodiment of the invention includes a combination of rooted spidering, ranking and displaying as to provide the user with a capability to perform intelligent navigation of the document collection. Thus, using an embodiment of the inventive system, the user is not longer dependent on the quality of link anchor text for navigational awareness. The user can now much more easily discover a relevant document two hops away from the current document. It also means that the user does not have to return to the initial search engine and repeat a search with more specific keywords, in order to find the exact right document that might be two links away from the current root. A side bar filled with relevance-ranked, link-near documents serves as an intelligent navigation tool for quickly, easily, and relevantly drilling one's way through a neighborhood of documents, for fine-tuning an initial query or otherwise intelligently browsing a collection.

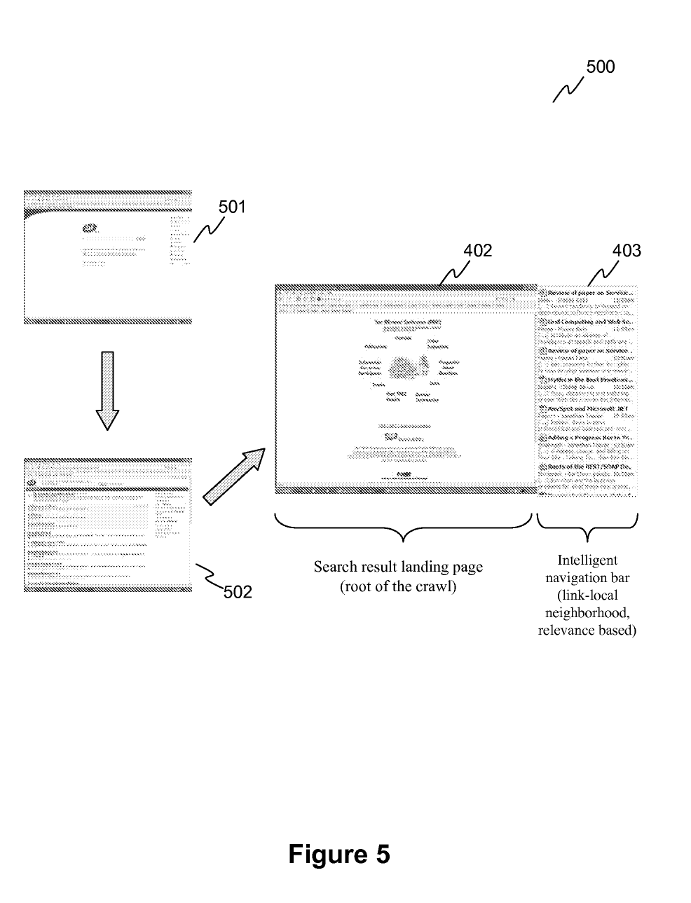

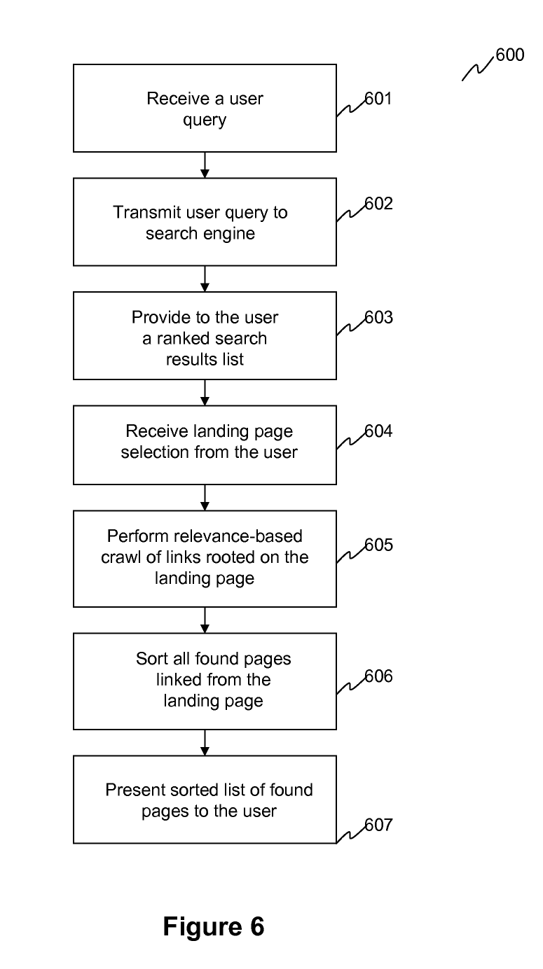

FIGS. 5 and 6 further illustrate operation of exemplary embodiment of the inventive system in a specific application. Specifically, FIG. 5 illustrates schematic operating sequence 500 of an embodiment of the inventive system applied to a web search engine. In that figure, the user starts with a search query page 501 of a search engine (not shown), which, in response to the aforesaid query, generates a ranked list of search results 502. Upon the user's selection of one of the results in the list 502, the inventive intelligent navigation system displays the selected (root) page 402 as well as a ranked list of link-nearest documents 403. The link-nearest documents 403 can be displayed in the shown navigation side bar.

FIG. 6 further illustrates an operating sequence 600 of the described embodiment of the inventive system, which may be implemented, for example, as a toolbar running on top of a web browser application. At step 601, the inventive system receives a user search query. At step 602, the received query is transmitted to a search engine. At step 603, the ranked search results list 502 generated by the search engine is presented to the user. At step 604, the system receives the selection of the landing page from the user. At step 605, the system performs relevance-based crawl of links rooted in the landing page to generate a list of link-nearest web pages. At step 606, an embodiment of the inventive system ranks the aforesaid list of link-nearest documents in accordance with relevance. Finally, at step 607, the ranked list of link-nearest documents is presented to the user using the inventive side-bar interface.

An advantage of an embodiment of the inventive approach is that a user may still browse a link-local document neighborhood, but do so in a manner that respects his or her current information need. No linked document environment is set up in exactly the manner every user wishes to browse it; the inventive approach gives the user more control over this relevance-based browsing experience.

A more technical advantage to an embodiment of inventive approach is that intelligent navigation tool is completely independent of the initial search engine. One may use any search engine for the initial ranking, and then implement the intelligent crawling and navigation bar in accordance with an embodiment of the invention on top of the results of that engine. There is no need to integrate or have access to any of the underlying search engine's technology.

Query-time crawling and ranking will not be instantaneous. However, because of the extreme locality of the crawl, as well as the relatively small number of documents that will be crawled, this should not take too long. Hopefully by the time the user has read a few sentences on the landing page, the system should be able to present the user with a full, relevance-based navigation side bar. If anything, the side bar can be populated almost immediately with the initial best first links, and then updated dynamically, with insertion sorts (as in a relevance-based priority queue), as more neighborhood links are crawled and discovered.

### Using “Best First” Spidering

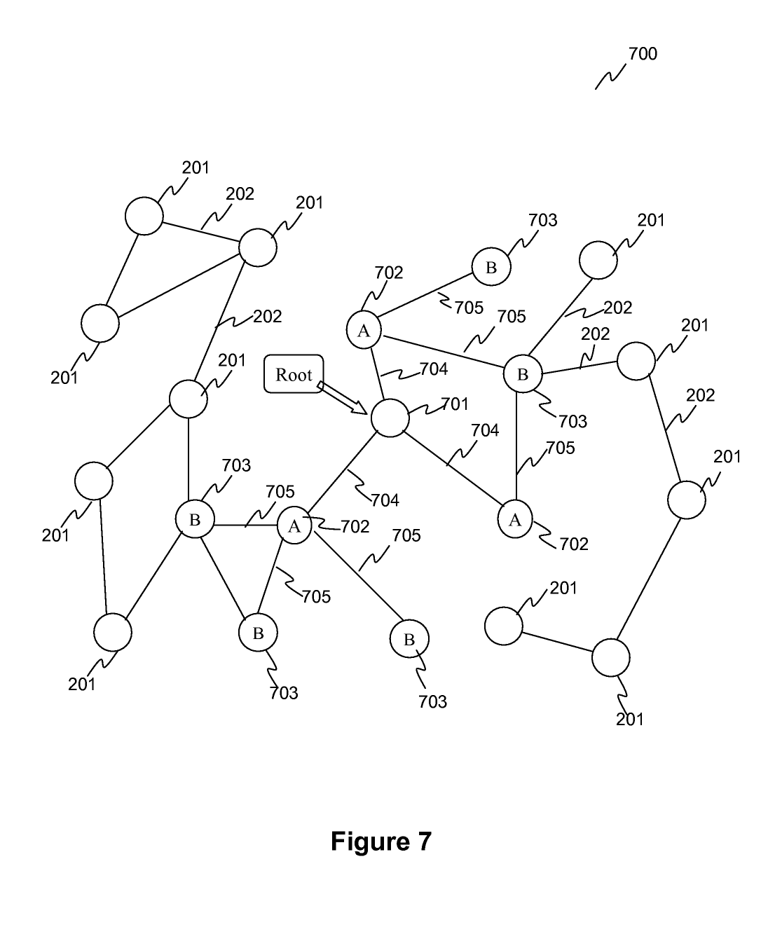

In the above-described embodiment of the invention, the query-time spidering was utilized as a way of discovering documents in the root document neighborhood. However, even if the link structure is already indexed, this operation is computationally expensive and potentially explosive in the number of web pages it retrieves. A typical spider follows what is known in graph search algorithms as a “Breadth First Search”, which is illustrated in FIG. 7. Specifically, in the shown example, the Breadth First Search system first uses the root document 701 to discover three links 704 pointing to three “A” documents 702. The aforesaid “A” document are separated from the root document by one link. After that, the system uses the three discovered “A” documents 702 to locate six links 705 pointing to five “B” documents 703, which are separated from the root document by two links. Thus, the Breadth First Search system first discovers the “A” document and then the “B” documents gradually expanding the breadth or the search in “all directions” and without regard to the content of the found nodes. For each new page that is discovered, all the previously unvisited links are added, in the order of discovery, to the crawl queue. If the link structure of the links in the document collection follows a power law distribution, this means that within just a few levels one could potentially “touch” a significant portion of the collection. The advantage of link locality is lost; one might as well just issue a global, collection-wide query.

To solve this problem, another embodiment of the inventive system utilizes a class of graph algorithms known as “best first” search algorithms. Breadth first search belongs to a class of general graph search algorithms that includes algorithms such as depth first search, depth-limited search, and iterative deepening search. These general algorithms are essentially node content agnostic; they are strategies that only look at the structure of the graph, rather than at the properties of the nodes being visited. Best first algorithms, on the other hand, order the graph traversal so that the next node (document) to be visited is the “best” node, as defined by some metric or heuristic.

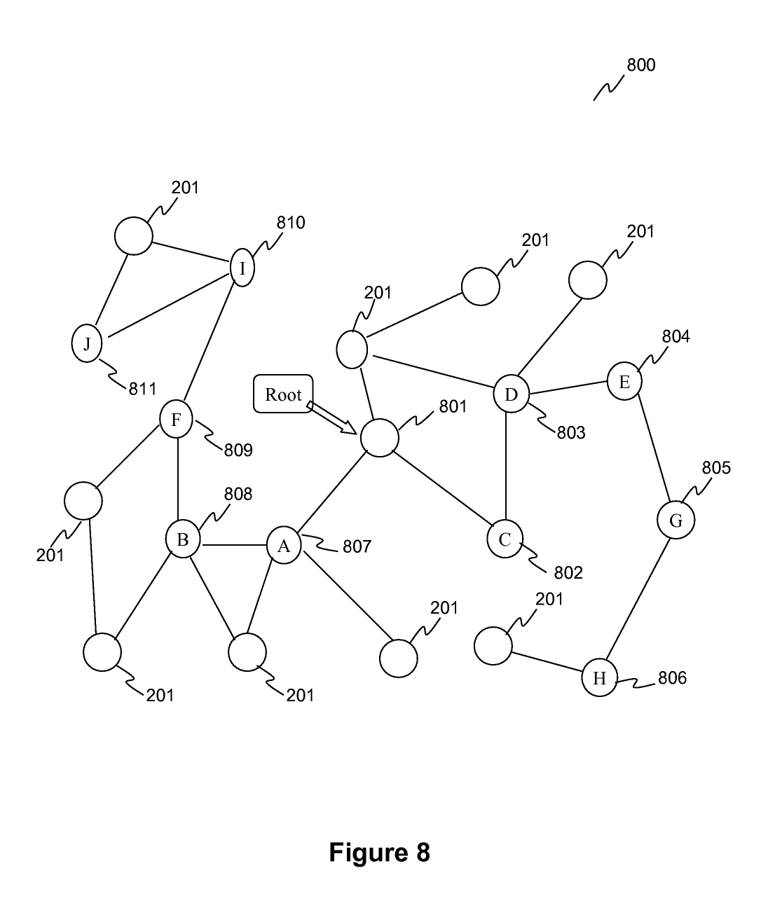

It is here that one can make use of a user's information need to better inform the spidering algorithm. Instead of crawling breadth first through the neighborhood, an embodiment of the inventive system uses the searcher's initial query paired with current node's document content to do a best first search based on relevance. As with the ranking module 109, above, any relevance algorithm (Okapi, TF.IDF, etc) can be used to determine the next best document (node). Thus, in an embodiment of the invention, the “best” nodes to expand are tied to the user's current information need. In this manner, the crawl automatically targets those best regions of the near neighborhood to open, without having to open up everything. One can go much deeper into certain regions, when needed, while avoiding large non-relevant regions at the same time. This will help not only efficiency, but could benefit effectiveness as well. FIG. 8 illustrates an example of the aforesaid Best First spidering technique traversing a linked node collection 800. The process starts with the root document 801. Instead of discovering any and all nodes linked from the root, the Best First system uses the content of the root as well as the user's query to determine that the “A” node 807 is the next best document from the point of view of user's information need. Thereafter, the Best First system determines that the “B” node 808 is the next best candidate. Pursuant to this methodology, the inventive Best First system sequentially discovers nodes 807, 808, 802, 803, 804, 809, 805, 806, 810 and 811, see FIG. 8.

### Intelligent Caching Rather Than Intelligent Navigation

In all of the examples above, it was assumed that the application of the intelligent spidering is link-local search navigation. Yet another embodiment of the invention applies the described inventive technique of “Best First” rooted spidering to other application, and specifically to intelligent caching.

There can be a situation when a user is going to be away from any sort of internet connection for some period of time, e.g. during a long overseas flight, during a business trip to a non-WIFI enabled, non-urban location, etc. In this situation, an embodiment of the inventive technique caches pages that the user likely needs to get access to, on the user's hard drive before the user loses his or her internet connection.

The problem is that one does not know which pages need to be cached, ahead of time. The obvious solution is to cache all the pages in a user's bookmarks or previously visited page list (History). And the next obvious solution is to cache all pages one link away from these bookmarks, i.e. a level-one breadth first crawl. However, sometimes the information that the user needs is not one link away, but two or three links away. Yet because of the exponential explosion of the web's linking structure, one could not cache all the pages that one would find in a level-three breadth first crawl.

Thus, the described embodiment of the inventive system caches all pages that are linked to a bookmark, in which there is some sort of semantic similarity. In other words, the aforesaid embodiment uses one of the bookmarked or previously visited web pages as a “root” page, and then applies the intelligent, “best first” spidering, extending out from that root. Pages that continue to be similar to that root, via document-to-document vector space similarity (or some other, interchangeable method) will continue to be cached and expanded, while paths that are not similar are pruned and not cached. This process is then repeated, for all the other “roots” in the user's bookmarks and previously visited pages.

The advantages of the inventive approach are twofold:

(1) By caching based on similar content, the user has a higher chance of gaining access to those pages he or she needs, while offline.

(2) One can judiciously limit the number of cached pages, based on hard drive size. For example, in the breadth-first, layer-1 approach, one never knows if the BFS will pull in 2 additional pages or 200 additional pages. It depends on how many links there are from the root page. With “best first” crawling, on the other hand, the system can choose, based on available hard disk space, to always cache the 5 best linked pages. Those five pages may all be linked to the root page, directly, or they may be chained, five layers deep. It depends on the content of the pages, and the “best first” algorithm. But with best first crawling, you have much more control over exactly how many pages you want to cache, and have higher confidence in the relevance of those cached pages.

### Exemplary Computer Platform

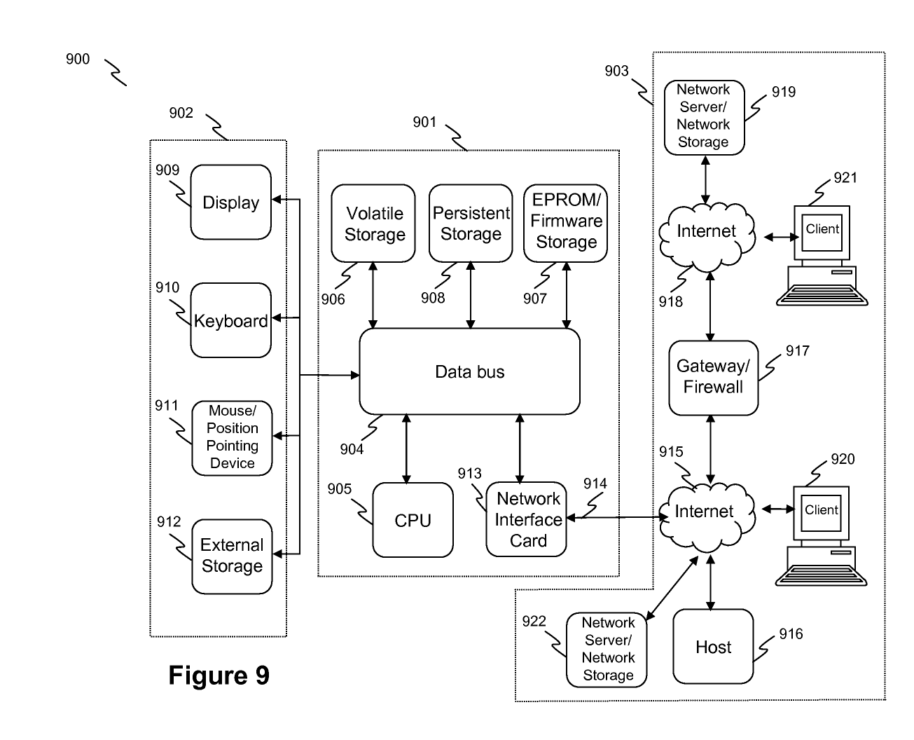

FIG. 9 is a block diagram that illustrates an embodiment of a computer/server system 900 upon which an embodiment of the inventive methodology may be implemented. The system 900 includes a computer/server platform 901, peripheral devices 902 and network resources 903.

The computer platform 901 may include a data bus 904 or other communication mechanism for communicating information across and among various parts of the computer platform 901, and a processor 905 coupled with bus 901 for processing information and performing other computational and control tasks. Computer platform 901 also includes a volatile storage 906, such as a random access memory (RAM) or other dynamic storage device, coupled to bus 904 for storing various information as well as instructions to be executed by processor 905. The volatile storage 906 also may be used for storing temporary variables or other intermediate information during execution of instructions by processor 905. Computer platform 901 may further include a read only memory (ROM or EPROM) 907 or other static storage device coupled to bus 904 for storing static information and instructions for processor 905, such as basic input-output system (BIOS), as well as various system configuration parameters. A persistent storage device 908, such as a magnetic disk, optical disk, or solid-state flash memory device is provided and coupled to bus 901 for storing information and instructions.

Computer platform 901 may be coupled via bus 904 to a display 909, such as a cathode ray tube (CRT), plasma display, or a liquid crystal display (LCD), for displaying information to a system administrator or user of the computer platform 901. An input device 910, including alphanumeric and other keys, is coupled to bus 901 for communicating information and command selections to processor 905. Another type of user input device is cursor control device 911, such as a mouse, a trackball, or cursor direction keys for communicating direction information and command selections to processor 904 and for controlling cursor movement on display 909. This input device typically has two degrees of freedom in two axes, a first axis (e.g., x) and a second axis (e.g., y), that allows the device to specify positions in a plane.

An external storage device 912 may be connected to the computer platform 901 via bus 904 to provide an extra or removable storage capacity for the computer platform 901. In an embodiment of the computer system 900, the external removable storage device 912 may be used to facilitate exchange of data with other computer systems.

The invention is related to the use of computer system 900 for implementing the techniques described herein. In an embodiment, the inventive system may reside on a machine such as computer platform 901. According to one embodiment of the invention, the techniques described herein are performed by computer system 900 in response to processor 905 executing one or more sequences of one or more instructions contained in the volatile memory 906. Such instructions may be read into volatile memory 906 from another computer-readable medium, such as persistent storage device 908. Execution of the sequences of instructions contained in the volatile memory 906 causes processor 905 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 905 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 908. Volatile media includes dynamic memory, such as volatile storage 906. Transmission media includes coaxial cables, copper wire and fiber optics, including the wires that comprise data bus 704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on the data bus 904. The bus 904 carries the data to the volatile storage 906, from which processor 905 retrieves and executes the instructions. The instructions received by the volatile memory 906 may optionally be stored on persistent storage device 908 either before or after execution by processor 905. The instructions may also be downloaded into the computer platform 901 via Internet using a variety of network data communication protocols well known in the art.

The computer platform 901 also includes a communication interface, such as network interface card 913 coupled to the data bus 904. Communication interface 913 provides a two-way data communication coupling to a network link 914 that is connected to a local network 915. For example, communication interface 913 may be an integrated services digital network (ISDN) card or a modem to provide a data communication connection to a corresponding type of telephone line. As another example, communication interface 913 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 913 sends and receives electrical, electromagnetic or optical signals that carry digital data streams representing various types of information.

Network link 913 typically provides data communication through one or more networks to other network resources. For example, network link 914 may provide a connection through local network 915 to a host computer 916, or a network storage/server 917. Additionally or alternatively, the network link 913 may connect through gateway/firewall 917 to the wide-area or global network 918, such as an Internet. Thus, the computer platform 901 can access network resources located anywhere on the Internet 918, such as a remote network storage/server 919. On the other hand, the computer platform 901 may also be accessed by clients located anywhere on the local area network 915 and/or the Internet 918. The network clients 920 and 921 may themselves be implemented based on the computer platform similar to the platform 901.

Local network 915 and the Internet 918 both use electrical, electromagnetic or optical signals that carry digital data streams. The signals through the various networks and the signals on network link 914 and through communication interface 913, which carry the digital data to and from computer platform 901, are exemplary forms of carrier waves transporting the information.

Computer platform 901 can send messages and receive data, including program code, through the variety of network(s) including Internet 918 and LAN 915, network link 914 and communication interface 913. In the Internet example, when the system 901 acts as a network server, it might transmit a requested code or data for an application program running on client(s) 920 and/or 921 through Internet 918, gateway/firewall 917, local area network 915 and communication interface 913. Similarly, it may receive code from other network resources.

The received code may be executed by processor 905 as it is received, and/or stored in persistent or volatile storage devices 908 and 906, respectively, or other non-volatile storage for later execution. In this manner, computer system 901 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized intelligent navigation and caching system. It is intended that the specification and examples be considered as exemplary only, with a true scope and spirit of the invention being indicated by the following claims.

What is claimed is:

1. A method comprising:
a. Receiving a user query from a user;
b. Transmitting the user query to a search engine;
c. Receiving search results from the search engine and providing the user with the received search results;
d. Receiving a landing document selection from the user, the landing document being selected by the user from the search results;
e. Performing a crawl of links rooted in the selected landing document to identify a plurality of link-near documents;
f. Sorting the plurality of the identified plurality of link-near documents; and
g. Presenting the sorted plurality of the identified plurality of link-near documents to the user.

2. The method of claim 1, wherein the search engine is a web search engine and wherein the landing document is a web page.

3. The method of claim 1, wherein the performed crawl is a relevance-based crawl.

4. The method of claim 1, wherein the sorted plurality of the identified plurality of link-near documents is presented to the user in a side bar portion of a user interface.

5. The method of claim 1, wherein the crawl is performed after the query is received from the user.

6. The method of claim 1, wherein performing a crawl comprises determining a plurality of link-nearest documents with respect to the selected landing document.

7. The method of claim 1, wherein performing a crawl comprises selecting a next link candidate based, at list in part, on a content of at least one found document.

8. The method of claim 1, wherein performing a crawl comprises selecting a next link candidate based, at list in part, on a similarity between a document corresponding to the next link candidate and the user query.

9. The method of claim 1, wherein performing a crawl comprises selecting a next link candidate based, at list in part, on a similarity between a document corresponding to the next link candidate and the landing document.

10. The method of claim 1, wherein performing a crawl comprises selecting a next link candidate based, at least in part, on a link proximity to the landing document.

11. The method of claim 1, wherein sorting is based, at least in part, on a similarity between a document in the plurality of the identified plurality of link-near documents and the user query.

12. The method of claim 11, wherein sorting is further based on a link popularity of the document in the plurality of the identified plurality of link-near documents.

13. The method of claim 11, wherein the similarity is computed using a TF.IDF comparison, a language model, an Okapi technique, or a vector space model.

14. The method of claim 1, wherein sorting is based, at least in part, on a similarity between a document in the plurality of the identified plurality of link-near documents and the landing document.

15. The method of claim 14, wherein the similarity is computed using a vector space similarity metric.

16. A method comprising:
a. Receiving a landing document selection from a user, the landing document being selected by the user from a collection of link-connected documents;
b. Performing a crawl of links rooted in the selected landing document to identify a plurality of link-near documents;
c. Sorting the plurality of the identified plurality of link-near documents; and
d. Presenting the sorted plurality of the identified plurality of link-near documents to the user.

17. The method of claim 16, wherein performing a crawl comprises selecting a next link candidate based, at least in part, on a similarity between a document corresponding to the next link candidate and the user query.

18. A method comprising:
a. Receiving a landing document selection from a user, the landing document being selected by the user from a collection of link-connected documents;
b. Performing a crawl of links rooted in the selected landing document to identify a plurality of link-near documents;
c. Caching the plurality of the identified plurality of link-near documents for subsequent access by the user.

19. The method of claim 18, wherein performing a crawl comprises selecting a next link candidate based, at least in part, on a similarity between a document corresponding to the next link candidate and the landing document.

20. The method of claim 18, wherein the landing document comprises a manually pre-selected document.

21. A computer-readable medium embodying a set of computer-executable instructions implementing a method comprising:
a. Receiving a user query from a user;
b. Transmitting the user query to a search engine;
c. Receiving search results from the search engine and providing the user with the received search results;
d. Receiving a landing document selection from the user, the landing document being selected by the user from the search results;
e. Performing a crawl of links rooted in the selected landing document to identify a plurality of link-near documents;
f. Sorting the plurality of the identified plurality of link-near documents; and
g. Presenting the sorted plurality of the identified plurality of link-near documents to the user.

22. A system comprising:
a. A rooted spidering module operable to receive a landing document selection from a user, the rooted spidering module operable to perform a crawl of links rooted in the selected landing document to identify a plurality of link-near documents;
b. A ranking module operable to sort the plurality of the identified plurality of link-near documents; and
c. A user interface operable to present the sorted plurality of the identified plurality of link-near documents to the user.

23. The system of claim 22, wherein the landing document is being selected by the user from a search results returned by a search engine in response to a user query.
